(19) United States
(12) Patent Application Publication
(10) Pub. No.: US 2026/0297989 A1
(43) Pub. Date: Oct. 1, 2026

(54) REMOTE CONTROL DEVICE

(71) Applicant: AISIN CORPORATION, Kariya, Aichi (JP)

(72) Inventors: Shinsuke TAKAYANAGI, Kariya-shi (JP); Akira MURAMATSU, Kariya-shi (JP); Takeshi TADA, Kariya-shi (JP); Yusuke NIIMI, Kariya-shi (JP); Kazuya YOKOYAMA, Kariya-shi (JP)

(73) Assignee: AISIN CORPORATION, Kariya, Aichi (JP)

(21) Appl. No.: 19/477,297

(22) PCT Filed: Jun. 4, 2024
(86) PCT No.: PCT/JP2024/020391

§ 371 Date: Oct. 21, 2025

(30) Foreign Application Priority Data
Jul. 13, 2023 (JP) 2023-115447

(51) Int. Cl. E05B 81/90; E05B 79/20

(52) U.S. Cl. CPC E05B 81/90; E05B 79/20

(57) ABSTRACT

A remote control device includes an emergency lever. When rotating in a second rotational direction, the emergency lever rotates a closing passive lever relative to a closing active lever to release closing cables from being pulled by the closing passive lever. When rotating in the second rotational direction, the emergency lever displaces a release passive lever relative to a release active lever to release opening cables from being pulled by the release passive lever.

### TECHNICAL FIELD

The present disclosure relates to a remote control device.

### BACKGROUND ART

Patent Literature 1 describes a vehicle with a vehicle body including a door opening and a sliding door that opens and closes the door opening. The vehicle body includes a first striker and a second striker. The sliding door includes a first latch mechanism and a second latch mechanism, a remote control device, a door lock actuator, and a plurality of cables.

The first latch mechanism is configured to be able to transition from a fully latched state in which the first latch mechanism is able to engage the first striker to an unlatched state in which the first latch mechanism is unable to engage the first striker, and vice versa. Likewise, the second latch mechanism is configured to be able to transition from a fully latched state in which the second latch mechanism is able to engage the second striker to an unlatched state in which the second latch mechanism is unable to engage the second striker, and vice versa. By transitioning to the fully latched states, the first latch mechanism and the second latch mechanism restrain the sliding door disposed in a fully closed position to the vehicle body.

The remote control device is connected to the door lock actuator via a release cable. The remote control device is connected to the first latch mechanism via a first opening cable and is connected to the second latch mechanism via a second opening cable. The remote control device relays power between the door lock actuator and the first latch mechanism and the second latch mechanism.

The door lock actuator performs a release operation to release the restraint of the sliding door to the vehicle body. The door lock actuator pulls the release cable in the release operation. Then, the remote control device pulls the first opening cable and the second opening cable. As a result, the first latch mechanism transitions to the unlatched state, and the second latch mechanism transitions to the unlatched state. Thus, the restraint of the sliding door to the vehicle body is released. Thereafter, the door lock actuator releases the release cable from being pulled. In this case, in the remote control device, the first opening cable and the second opening cable are also released from being pulled.

In a case where the door lock actuator becomes inoperative in a state of pulling the release cable, the first latch mechanism and the second latch mechanism become unable to transition from the unlatched state to another state. Specifically, the first latch mechanism and the second latch mechanism become unable to restrain the sliding door to the vehicle body in the fully closed position. In this regard, the remote control device includes a cancellation mechanism that interrupts power transmission paths between the door lock actuator and the first latch mechanism and the second latch mechanism, based on a user's manual operation. Therefore, in the above case, by causing the cancellation mechanism to function, the first latch mechanism and the second latch mechanism become able to transition to the fully latched state.

### CITATIONS LIST

### Patent Literature

Patent Literature 1: JP 2020-204225 A

### SUMMARY OF INVENTION

### Technical Problems

In the vehicle as described above, the door lock actuator may be configured to perform a closing operation to cause the first latch mechanism and the second latch mechanism to transition to the fully latched state via the remote control device. In this case, in preparation for a case where the door lock actuator becomes inoperative during the closing operation, the remote control device may include a cancellation mechanism that interrupts power transmission paths between the door lock actuator and the first latch mechanism and the second latch mechanism during the closing operation. However, it is preferable that this cancellation mechanism be easy for the user to operate.

### Solutions to Problems

A remote control device according to an aspect of the present disclosure is applied to a door that opens and closes a door opening of a vehicle body including a first striker and a second striker. The door includes a first door locking device that is able to transition to a fully latched state in which the first door locking device is able to engage the first striker, and to an unlatched state in which the first door locking device is unable to engage the first striker, and a second door locking device that is able to transition to a fully latched state in which the second door locking device is able to engage the second striker, and to an unlatched state in which the second door locking device is unable to engage the second striker. The remote control device includes a closing passive lever connected to the first door locking device via a first closing cable and connected to the second door locking device via a second closing cable, a closing active lever that drives the closing passive lever, a release passive lever connected to the first door locking device via a first opening cable and connected to the second door locking device via a second opening cable, a release active lever that drives the release passive lever, and an emergency lever that drives the closing passive lever and the release passive lever. The first door locking device is caused to transition to the unlatched state by the first opening cable being pulled, and is caused to transition to the fully latched state by the first closing cable being pulled. The second door locking device is caused to transition to the unlatched state by the second opening cable being pulled, and is caused to transition to the fully latched state by the second closing cable being pulled. The closing active lever causes the closing passive lever to pull the first closing cable and the second closing cable when rotating in a first forward rotational direction, and releases the first closing cable and the second closing cable from being pulled by the closing passive lever when rotating in a first reverse rotational direction that is a direction opposite to the first forward rotational direction. The release active lever causes the release passive lever to pull the first opening cable and the second opening cable when rotating in a second forward rotational direction, and releases the first opening cable and the second opening cable from being pulled by the release passive lever when rotating in a second reverse rotational direction that is a direction opposite to the second forward rotational direction. When rotating in a third forward rotational direction, the emergency lever releases the first closing cable and the second closing cable from being pulled by the closing passive lever by displacing the closing passive lever relative to the closing active lever, and releases the first opening cable and the second opening cable from being pulled by the release passive lever by displacing the release passive lever relative to the release active lever.

### Advantageous Effects of Invention

The remote control device can make an operation to release the first closing cable and the second closing cable from being pulled and an operation to release the first opening cable and the second opening cable from being pulled simple for the user.

### BRIEF DESCRIPTION OF DRAWINGS

FIG. 1 is a side view illustrating a schematic configuration of a vehicle.

FIG. 2 is a schematic view of an upper locking device, a lower locking device, and a front locking device in an unlatched state in the vehicle illustrated in FIG. 1.

FIG. 3 is a schematic view of the upper locking device and the lower locking device in the vehicle illustrated in FIG. 1.

FIG. 4 is a schematic view of the front locking device in the vehicle illustrated in FIG. 1.

FIG. 5 is a front view of a remote control device in the vehicle illustrated in FIG. 1.

FIG. 6 is a rear view of the remote control device in the vehicle illustrated in FIG. 1.

FIG. 7 is a front view of a first remote control unit of the remote control device in the vehicle illustrated in FIG. 1.

FIG. 8 is an exploded perspective view of the first remote control unit of the remote control device in the vehicle illustrated in FIG. 1.

FIG. 9 is a front view of a second remote control unit of the remote control device in the vehicle illustrated in FIG. 1.

FIG. 10 is an exploded perspective view of the second remote control unit of the remote control device in the vehicle illustrated in FIG. 1.

FIG. 11 is a schematic view of the upper locking device, the lower locking device, and the front locking device in a half-latched state in the vehicle illustrated in FIG. 1.

FIG. 12 is a schematic view of the upper locking device, the lower locking device, and the front locking device in a fully latched state in the vehicle illustrated in FIG. 1.

FIG. 13 is a front view of the second remote control unit during a closing operation in the vehicle illustrated in FIG. 1.

FIG. 14 is a front view of the second remote control unit during a closing cancellation operation in the vehicle illustrated in FIG. 1.

FIG. 15 is a front view of the first remote control unit during a release operation in the vehicle illustrated in FIG. 1.

FIG. 16 is a front view of the first remote control unit during a release cancellation operation in the vehicle illustrated in FIG. 1.

FIG. 17 is a front view of the first remote control unit during the release cancellation operation in the vehicle illustrated in FIG. 1.

### DESCRIPTION OF EMBODIMENTS

Hereinafter, an embodiment of a vehicle 10 including a remote control device 100 will be described.

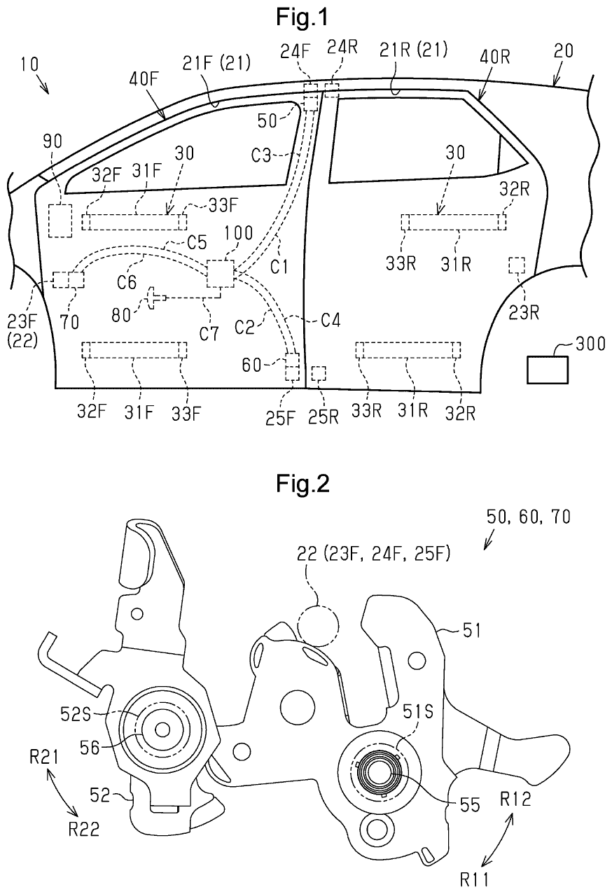

As illustrated in FIG. 1, the vehicle 10 includes a vehicle body 20, a door support mechanism 30, a front door 40F, a rear door 40R, and a door control device 300.

### <Vehicle Body 20>

The vehicle body 20 includes a door opening 21 open at the side. The vehicle body 20 includes a plurality of strikers 22 disposed along the edge of the door opening 21.

The door opening 21 includes a front opening 21F that is a front portion of the door opening 21 and a rear opening 21R that is a rear portion of the door opening 21. In the present embodiment, no pillar is present between the front opening 21F and the rear opening 21R. In another embodiment, the vehicle body 20 may include a pillar that demarcates the front opening 21F and the rear opening 21R.

The plurality of strikers 22 include a front striker 23F, a rear striker 23R, two upper strikers 24F and 24R, and two lower strikers 25F and 25R.

The front striker 23F is located at a front edge portion of the door opening 21. The rear striker 23R is located at a rear edge portion of the door opening 21. The two upper strikers 24F and 24R are located at upper edge portions of the door opening 21 that are longitudinally central portions of the door opening 21. The two upper strikers 24F and 24R are arranged in the longitudinal direction. The two lower strikers 25F and 25R are located at lower edge portions of the door opening 21 that are longitudinally central portions of the door opening 21. The two lower strikers 25F and 25R are arranged in the longitudinal direction. Among the plurality of strikers 22, the front striker 23F, the upper striker 24F, and the lower striker 25F correspond to parts to be connected to the front door 40F in the vehicle body 20. On the other hand, among the plurality of strikers 22, the rear striker 23R, the upper striker 24R, and the lower striker 25R correspond to parts to be connected to the rear door 40R in the vehicle body 20. The upper striker 24F corresponds to a “first striker”, and the lower striker 25F corresponds to a “second striker”.

### <Door Support Mechanism 30>

The door support mechanism 30 includes two front links 31F that connect the vehicle body 20 and the front door 40F, and two rear links 31R that connect the vehicle body 20 and the rear door 40R.

The two front links 31F are offset from each other in the vertical direction. Each front link 31F includes a hinge 32F and a hinge 33F whose axial directions are the vertical direction. The hinge 32F and the hinge 33F are individually located at both ends of the front link 31F in the longitudinal direction. The hinge 32F is fixed to the vicinity of the front edge of the door opening 21 in the vehicle body 20, and the hinge 33F is fixed to the front door 40F. Thus, the vehicle body 20, the two front links 31F, and the front door 40F constitute a link mechanism.

The two rear links 31R are offset from each other in the vertical direction. Each rear link 31R includes a hinge 32R and a hinge 33R whose axial directions are the vertical direction. The hinge 32R and the hinge 33R are individually located at both ends of the rear link 31R in the longitudinal direction. The hinge 32R is fixed to the vicinity of the rear edge of the door opening 21 in the vehicle body 20, and the hinge 33R is fixed to the rear door 40R. Thus, the vehicle body 20, the two rear links 31R, and the rear door 40R constitute a link mechanism.

Consequently, the front door 40F swings along an arc-shaped path between a fully closed position at which the front opening 21F is fully closed and a fully opened position at which the front opening 21F is fully opened. On the other hand, the rear door 40R swings along an arc-shaped and linear path between a fully closed position at which the rear opening 21R is fully closed and a fully opened position at which the rear opening 21R is fully opened. When the front door 40F and the rear door 40R simultaneously perform opening operations, the front door 40F and the rear door 40R move in directions away from each other. On the other hand, when the front door 40F and the rear door 40R simultaneously perform closing operations, the front door 40F and the rear door 40R move in directions approaching each other. That is, the opening direction of the front door 40F is opposite to the opening direction of the rear door 40R, and the closing direction of the front door 40F is opposite to the closing direction of the rear door 40R.

### <Front Door 40F>

As illustrated in FIG. 1, the front door 40F includes an upper locking device 50, a lower locking device 60, a front locking device 70, an operating part 80, a door actuator 90, the remote control device 100, and a plurality of cables C1 to C7. The front door 40F corresponds to a “door”. The rear door 40R has the same configuration as the front door 40F, and thus will not be described below.

### <Upper Locking Device 50 and Lower Locking Device 60>

As illustrated in FIG. 1, the upper locking device 50 is provided at a position near the rear edge of the front door 40F and near the upper edge of the front door 40F. The lower locking device 60 is provided at a position near the rear edge of the front door 40F and near the lower edge of the front door 40F. The upper locking device 50 and the lower locking device 60 have the same configuration. The upper locking device 50 corresponds to a “first door locking device”, and the lower locking device 60 corresponds to a “second door locking device”.

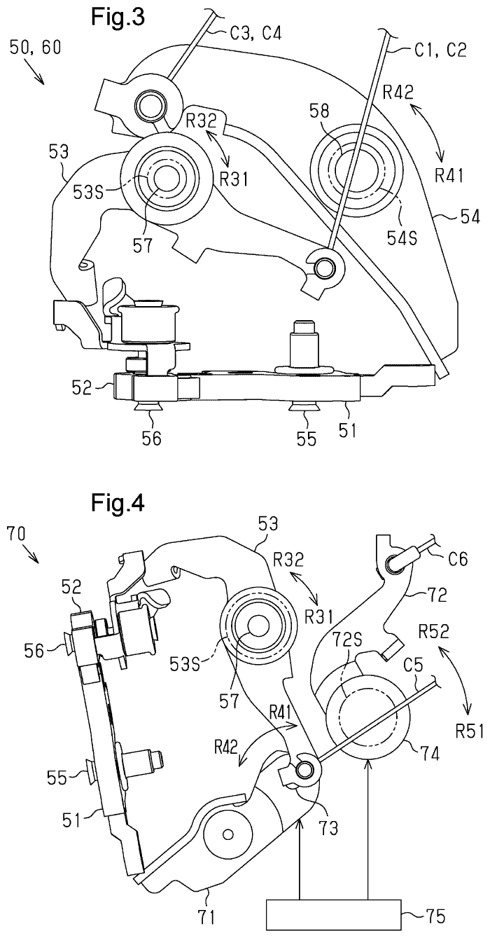

As illustrated in FIGS. 2 and 3, the upper locking device 50 and the lower locking device 60 include a latch 51, a pawl 52, an opening lever 53, and a closing lever 54. The upper locking device 50 and the lower locking device 60 also include a latch support shaft 55, a pawl support shaft 56, an opening lever support shaft 57, and a closing lever support shaft 58. The upper locking device 50 and the lower locking device 60 further include a latch spring 51S, a pawl spring 52S, an opening lever spring 53S, and a closing lever spring 54S.

As illustrated in FIG. 2, the latch 51 includes a recess that depends on the thickness of the striker 22. The latch 51 is rotatably supported by the latch support shaft 55. The latch 51 is biased in a first rotational direction R11 by the latch spring 51S. The pawl 52 is rotatably supported by the pawl support shaft 56. The pawl 52 is biased in a second rotational direction R22 by the pawl spring 52S. The axis of the latch support shaft 55 and the axis of the pawl support shaft 56 are oriented in substantially the same direction.

As illustrated in FIG. 3, the opening lever 53 is rotatably supported by the opening lever support shaft 57. A first end of the upper opening cable C1 is connected to the opening lever 53 of the upper locking device 50. A first end of the lower opening cable C2 is connected to the opening lever 53 of the lower locking device 60. The opening lever 53 is biased in a first rotational direction R31 by the opening lever spring 53S.

The closing lever 54 is rotatably supported by the closing lever support shaft 58. A first end of the upper closing cable C3 is connected to the closing lever 54 of the upper locking device 50. A first end of the lower closing cable C4 is connected to the closing lever 54 of the lower locking device 60. The closing lever 54 is biased in a second rotational direction R42 by the closing lever spring 54S.

The axis of the opening lever support shaft 57 and the axis of the closing lever support shaft 58 are oriented in substantially the same direction. The axis of the opening lever support shaft 57 and the axis of the closing lever support shaft 58 have twisted positional relationships with the axis of the latch support shaft 55 and the axis of the pawl support shaft 56.

### <Front Locking Device 70>

Many of the components of the front locking device 70 are the same as the components of the upper locking device 50. Therefore, of the components of the front locking device 70, components common to the upper locking device 50 are denoted by the same reference numerals to omit descriptions thereof.

As illustrated in FIGS. 2 and 4, the front locking device 70 includes a latch 51, a pawl 52, an opening lever 53, a latch support shaft 55, a pawl support shaft 56, and an opening lever support shaft 57 as components common to the upper locking device 50. The front locking device 70 also includes a latch spring 51S, a pawl spring 52S, and an opening lever spring 53S. As illustrated in FIG. 4, the front locking device 70 includes a closing lever 71, a release lever 72, a closing lever support shaft 73, a release lever support shaft 74, and a release lever spring 72S as components not common to the upper locking device 50. The front locking device 70 also includes a first door lock actuator 75.

The opening lever 53 is rotatably supported by the opening lever support shaft 57. A first end of the front opening cable C5 is connected to the opening lever 53. The opening lever 53 is biased in a first rotational direction R31 by the opening lever spring 53S. The closing lever 71 is rotatably supported by the closing lever support shaft 73. The release lever 72 is rotatably supported by the release lever support shaft 74. A first end of the release cable C6 is connected to the release lever 72. The release lever 72 is biased in a first rotational direction R51 by the release lever spring 72S. The axis of the opening lever support shaft 57 and the axis of the closing lever support shaft 73 are oriented in substantially the same direction.

### <First Door Lock Actuator 75>

The first door lock actuator 75 drives the closing lever 71 and the release lever 72. Specifically, the first door lock actuator 75 rotates the closing lever 71 in a first rotational direction R41 and the second rotational direction R42, and rotates the release lever 72 in the first rotational direction R51 and a second rotational direction R52. The first door lock actuator 75 includes an electric motor and a transmission mechanism that transmits the power of the electric motor to the closing lever 71 and the release lever 72. As an example, the transmission mechanism of the first door lock actuator 75 preferably includes a gear that drives only the closing lever 71 when rotating in one direction from a reference position and drives only the release lever 72 when rotating in the opposite direction from the reference position.

### <Operating Part 80>

As illustrated in FIG. 1, a first end of the emergency cable C7 is connected to the operating part 80. The operating part 80 only needs to be able to pull the emergency cable C7 when being operated by a user or the like. For example, the operating part 80 may have a lever shape or a button shape. However, a direction in which the operating part 80 is operated, that is, a direction in which the operating part 80 moves to pull the emergency cable C7 is a single direction.

### <Remote Control Device 100>

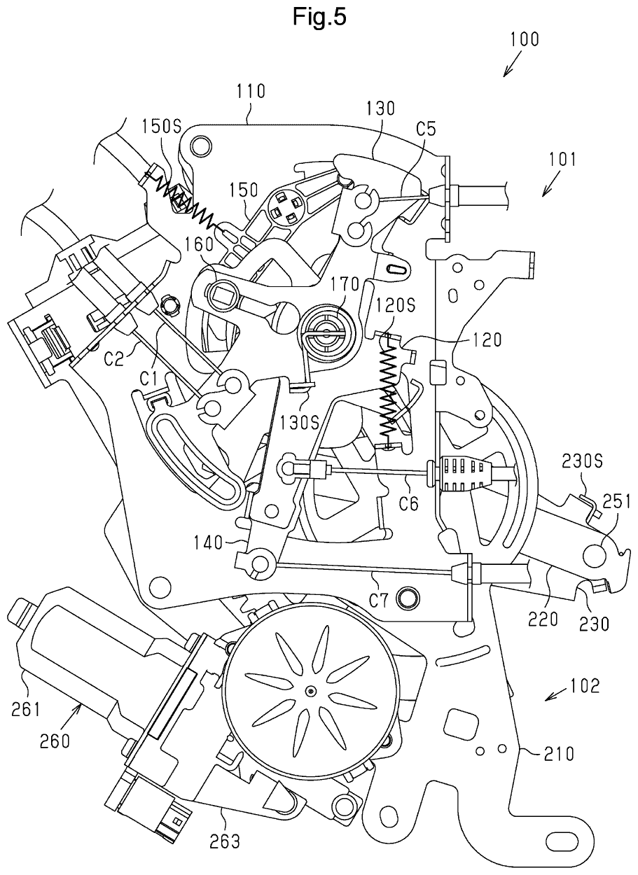

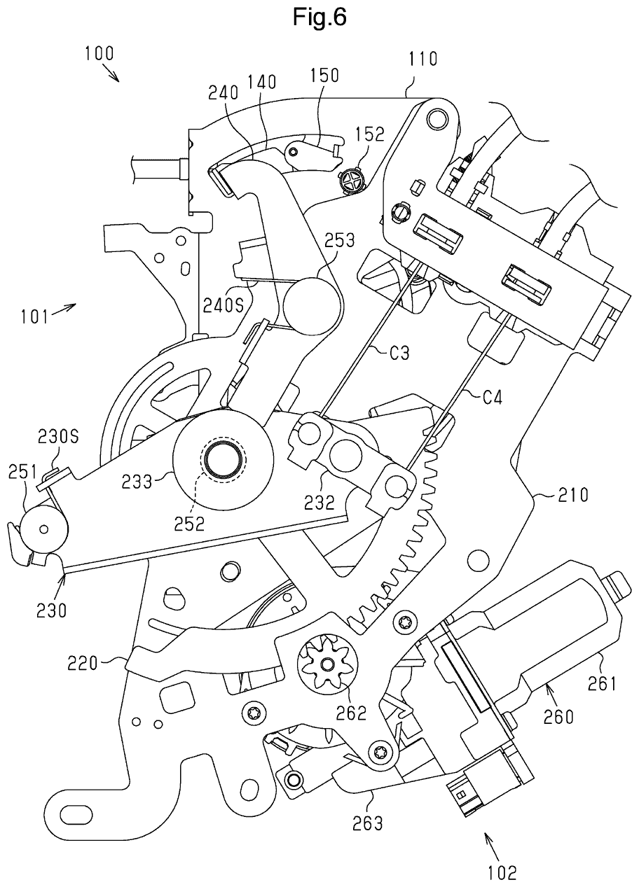

As illustrated in FIGS. 5 and 6, the remote control device 100 includes a first remote control unit 101 mainly including components related to a release operation, and a second remote control unit 102 mainly including components related to a closing operation.

### <First Remote Control Unit 101>

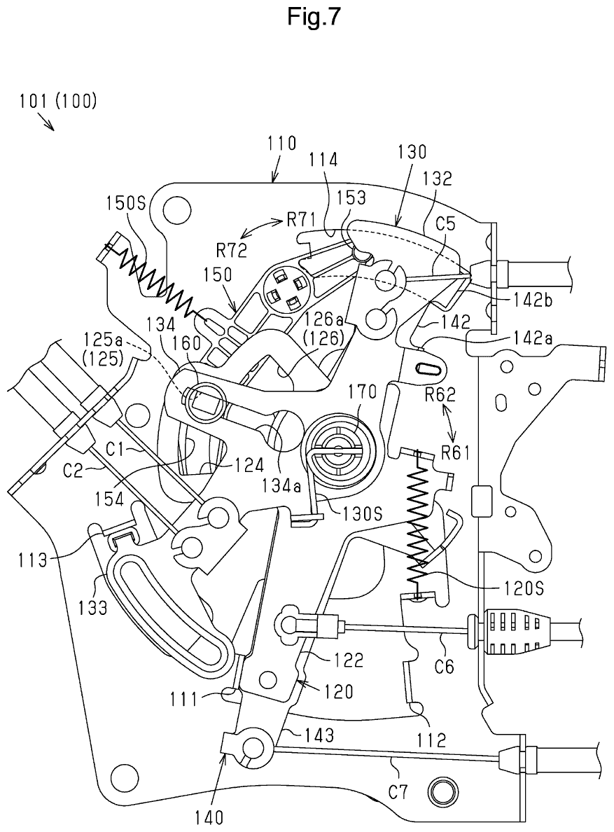

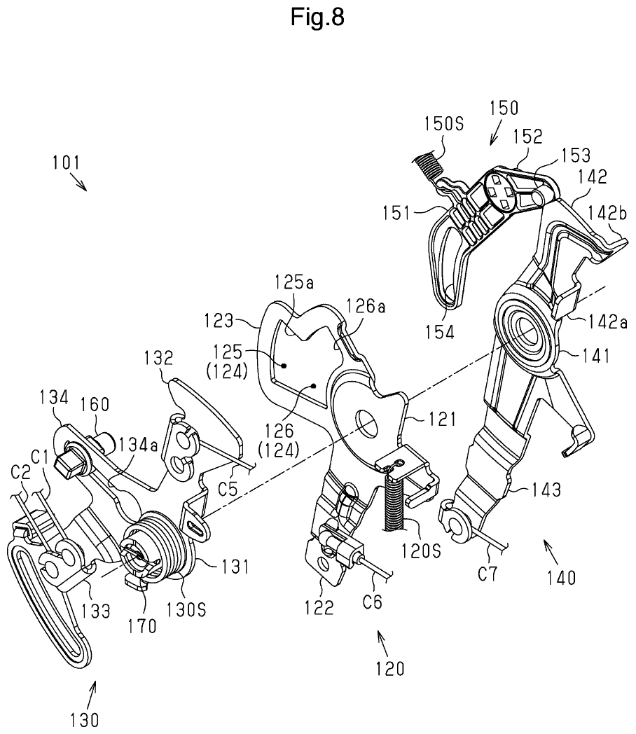

As illustrated in FIGS. 7 and 8, the first remote control unit 101 includes a first base 110, a release active lever 120, a release passive lever 130, an emergency lever 140, a locking lever 150, and a locking pin 160. The first remote control unit 101 also includes a lever support shaft 170, a release active lever spring 120S, a release passive lever spring 130S, and a locking lever spring 150S.

In the following description, the release active lever 120 is referred to as the “RA lever 120”, and the release passive lever 130 is referred to as the “RP lever 130”. The release active lever spring 120S is referred to as the “RA lever spring 120S”, and the release passive lever spring 130S is referred to as the “RP lever spring 130S”.

As illustrated in FIG. 7, the first base 110 has a plate shape. The first base 110 includes a plurality of stoppers 111 to 113 for positioning a plurality of levers. The plurality of stoppers 111 to 113 are formed by cutting and raising portions of the first base 110. The first base 110 includes a plurality of openings passing therethrough in the plate thickness direction. The first base 110 includes a communication hole 114 as one of the plurality of openings. The communication hole 114 extends in an arc shape as viewed from the front of the first base 110 in the plate thickness direction. In the first base 110, the lever support shaft 170 is fixed at the position corresponding to the center of the arc-shaped communication hole 114. The axis of the lever support shaft 170 extends in the plate thickness direction of the first base 110.

As illustrated in FIGS. 7 and 8, the RA lever 120 has a plate shape. The RA lever 120 includes a base portion 121, a first arm 122, and a guide portion 123. The base portion 121 corresponds to a central portion of the RA lever 120. The RA lever 120 is rotatably supported by the lever support shaft 170 via the base portion 121. The first arm 122 extends from the base portion 121. A second end of the release cable C6 is connected to a distal end portion of the first arm 122. In a front view in the plate thickness direction, the guide portion 123 extends from the base portion 121, increasing in width with distance from the base portion 121. The guide portion 123 includes a guide hole 124 passing therethrough in the plate thickness direction. The guide hole 124 includes a first portion 125 that is a portion far from the base portion 121 and a second portion 126 that is a portion close to the base portion 121. In a front view in the plate thickness direction, the first portion 125 and the second portion 126 extend in an arc shape centered on the base portion 121. The circumferential length of the first portion 125 is less than the circumferential length of the second portion 126. Thus, in the circumferential direction, a first side surface 125a demarcating the first portion 125 and a second side surface 126a demarcating the second portion 126 are offset from each other.

As illustrated in FIG. 7, a first end of the RA lever spring 120S is engaged with the RA lever 120, and a second end of the RA lever spring 120S is engaged with the first base 110. Thus, the RA lever spring 120S biases the RA lever 120 in a first rotational direction R61. Consequently, the first arm 122 of the RA lever 120 is in contact with the stopper 111 of the first base 110.

As illustrated in FIGS. 7 and 8, the RP lever 130 has a plate shape. The RP lever 130 includes a base portion 131, a second arm 132, a third arm 133, and a fourth arm 134. The base portion 131 corresponds to a central portion of the RP lever 130. The RP lever 130 is rotatably supported by the lever support shaft 170 via the base portion 131. The second arm 132, the third arm 133, and the fourth arm 134 extend from the base portion 131 in different directions. A second end of the front opening cable C5 is connected to a distal end portion of the second arm 132. A second end of the upper opening cable C1 and a second end of the lower opening cable C2 are connected to a distal end portion of the third arm 133. The fourth arm 134 includes a guide groove 134a extending in the longitudinal direction of the fourth arm 134. The guide groove 134a passes through the fourth arm 134 in the plate thickness direction.

As illustrated in FIG. 7, a first end of the RP lever spring 130S is engaged with the lever support shaft 170, and a second end of the RP lever spring 130S is engaged with the RP lever 130. Thus, the RP lever spring 130S biases the RP lever 130 in the first rotational direction R61. Consequently, as illustrated in FIG. 7, the third arm 133 of the RP lever 130 is in contact with the stopper 113 of the first base 110.

As illustrated in FIGS. 7 and 8, the emergency lever 140 has a plate shape. The emergency lever 140 includes a base portion 141, a fifth arm 142, and a sixth arm 143. The base portion 141 corresponds to a central portion of the emergency lever 140. The emergency lever 140 is rotatably supported by the lever support shaft 170 via the base portion 141. The fifth arm 142 and the sixth arm 143 extend from the base portion 141 in different directions. The fifth arm 142 includes a first pressing portion 142a and a second pressing portion 142b. The first pressing portion 142a is located at a longitudinally intermediate portion of the fifth arm 142. The second pressing portion 142b is located at a distal end portion of the fifth arm 142. The first pressing portion 142a and the second pressing portion 142b are bent in the plate thickness direction of the fifth arm 142. However, the extending direction of the first pressing portion 142a is opposite to the extending direction of the second pressing portion 142b. As illustrated in FIG. 7, the second pressing portion 142b passes through the communication hole 114 in the first base 110. A second end of the emergency cable C7 is connected to a distal end portion of the sixth arm 143.

In the present embodiment, the RA lever 120, the RP lever 130, and the emergency lever 140 are stacked in the plate thickness direction of the first base 110. Specifically, the RP lever 130 is located farthest from the first base 110, and the emergency lever 140 is located closest to the first base 110. The RA lever 120 is located between the RP lever 130 and the emergency lever 140. The RA lever 120, the RP lever 130, and the emergency lever 140 are supported by the lever support shaft 170. In this respect, the rotation axis of the RA lever 120, the rotation axis of the RP lever 130, and the rotation axis of the emergency lever 140 coincide.

As illustrated in FIGS. 7 and 8, the locking lever 150 includes a link 151, a rotating shaft 152, and an engaging shaft 153. The locking lever 150 is formed, for example, of a resin material. The link 151 has a plate shape. When the link 151 is viewed from the plate thickness direction, the link 151 extends in an arc shape. The link 151 includes a sliding groove 154 extending in the longitudinal direction of the link 151. The sliding groove 154 is located between a longitudinally intermediate portion and a first end of the link 151. The rotating shaft 152 extends from the link 151 in the plate thickness direction of the link 151. The rotating shaft 152 is located at a longitudinally central portion of the link 151. The locking lever 150 is supported by the first base 110 via the rotating shaft 152. Thus, the locking lever 150 is rotatable relative to the first base 110. The engaging shaft 153 extends from the link 151 in the plate thickness direction of the link 151. The projecting direction of the engaging shaft 153 is opposite to the projecting direction of the rotating shaft 152. The engaging shaft 153 is located at a second end portion of the link 151 in the longitudinal direction.

As illustrated in FIG. 7, a first end of the locking lever spring 150S is engaged with the first base 110, and a second end of the locking lever spring 150S is engaged with the locking lever 150. Thus, the locking lever spring 150S biases the locking lever 150 in a first rotational direction R71. Consequently, as illustrated in FIG. 8, the engaging shaft 153 of the locking lever 150 is in contact with a distal end portion of the fifth arm 142 of the emergency lever 140.

As illustrated in FIGS. 7 and 8, the locking pin 160 has a columnar shape. The locking pin 160 is inserted through the guide hole 124 of the RA lever 120, the guide groove 134a of the RP lever 130, and the sliding groove 154 of the locking lever 150. Thus, the locking pin 160 connects the RA lever 120, the RP lever 130, and the locking lever 150. The locking pin 160 is immovable in the plate thickness direction of the RA lever 120, the RP lever 130, and the locking lever 150. On the other hand, the locking pin 160 is movable in a direction perpendicular to the plate thickness direction of the RA lever 120, the RP lever 130, and the locking lever 150. Specifically, the locking pin 160 is movable inside the guide hole 124 relative to the RA lever 120. The locking pin 160 is movable along the guide groove 134a relative to the RP lever 130. The locking pin 160 is movable along the sliding groove 154 relative to the locking lever 150. In the following description, the position of the locking pin 160 illustrated in FIG. 7 is referred to as a “connection position”.

### <Second Remote Control Unit 102>

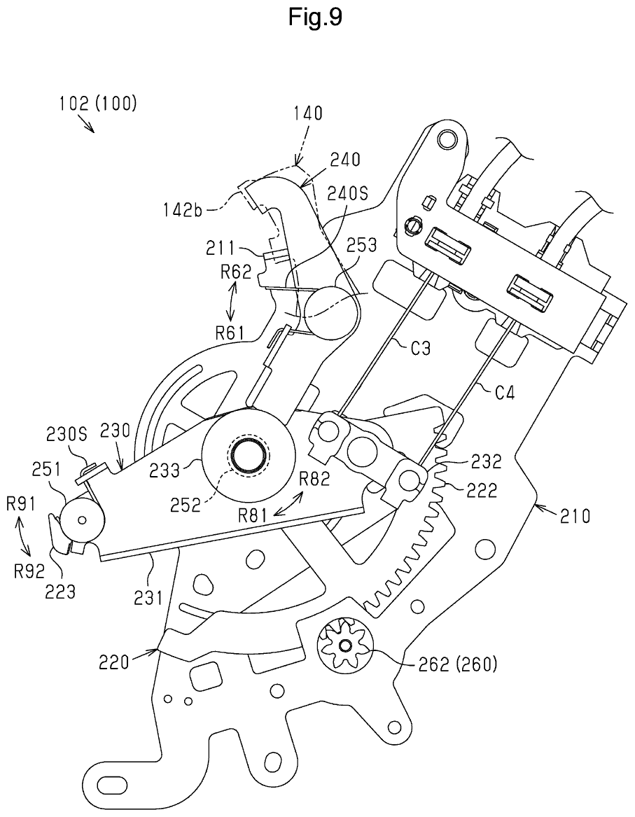

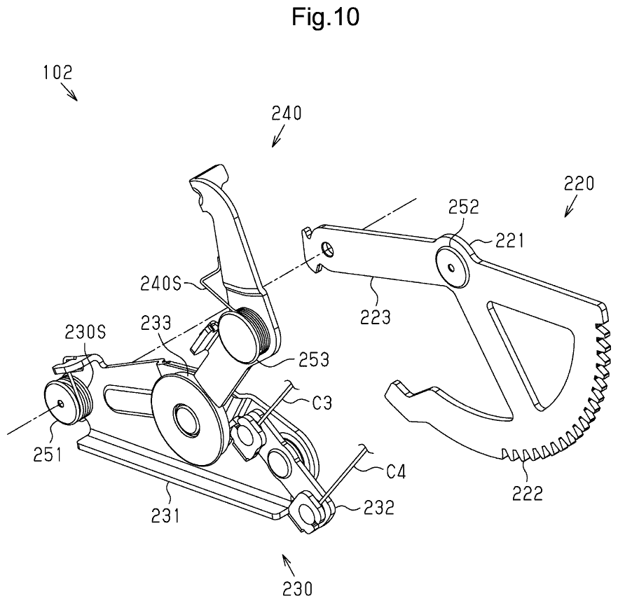

As illustrated in FIGS. 9 and 10, the second remote control unit 102 includes a second base 210, a closing active lever 220, a closing passive lever 230, and a cancellation lever 240. The second remote control unit 102 also includes a connecting shaft 251, a closing active lever support shaft 252, a cancellation lever support shaft 253, a closing passive lever spring 230S, and a cancellation lever spring 240S. As illustrated in FIGS. 5 and 6, the second remote control unit 102 further includes a second door lock actuator 260.

In the following description, the closing active lever 220 is referred to as the “CA lever 220”, and the closing passive lever 230 is referred to as the “CP lever 230”. The closing active lever support shaft 252 is referred to as the “CA lever support shaft 252”, and the closing passive lever spring 230S is referred to as the “CP lever spring 230S”.

As illustrated in FIG. 9, the second base 210 has a plate shape. The second base 210 includes a stopper 211 that defines the rotation range of the cancellation lever 240. The stopper 211 is formed by cutting and raising a portion of the second base 210. The CA lever support shaft 252 and the cancellation lever support shaft 253 are fixed to the second base 210. The axis of the CA lever support shaft 252 and the axis of the cancellation lever support shaft 253 both extend in the plate thickness direction of the second base 210.

As illustrated in FIGS. 9 and 10, the CA lever 220 has a plate shape. The CA lever 220 includes a base portion 221, a sector gear 222, and a seventh arm 223. The base portion 221 corresponds to a central portion of the CA lever 220. The CA lever 220 is rotatably supported by the CA lever support shaft 252 via the base portion 221. When the CA lever 220 is viewed from the plate thickness direction, the sector gear 222 has a fan shape centered on the base portion 221. The sector gear 222 includes a gear train extending in an arc shape. The seventh arm 223 extends from the base portion 221.

The CP lever 230 includes a swing arm 231, a balancer 232, and a roller 233. The swing arm 231 has a long plate shape. A proximal end portion of the swing arm 231 in the longitudinal direction is connected to a distal end portion of the seventh arm 223 of the CA lever 220 by the connecting shaft 251. Thus, the CP lever 230 is rotatable relative to the CA lever 220 about the axis of the connecting shaft 251. A distal end portion of the swing arm 231 in the longitudinal direction rotatably supports the balancer 232. A second end of the upper closing cable C3 and a second end of the lower closing cable C4 are connected to the balancer 232. The roller 233 has a disk shape. The roller 233 is located at a central portion between the proximal end portion and the distal end portion of the swing arm 231. The roller 233 may be rotatable or non-rotatable relative to the swing arm 231.

As illustrated in FIG. 9, a first end of the CP lever spring 230S is engaged with the seventh arm 223 of the CA lever 220, and a second end of the CP lever spring 230S is engaged with the swing arm 231 of the CP lever 230. Thus, the CP lever spring 230S biases the CP lever 230 in a first rotational direction R91 with respect to the CA lever 220.

As illustrated in FIGS. 9 and 10, the cancellation lever 240 has a plate shape. The cancellation lever 240 has an L shape in a front view in the plate thickness direction. The cancellation lever 240 is rotatably supported by the cancellation lever support shaft 253. Here, the rotation axis of the cancellation lever 240 coincides with the rotation axis of the RA lever 120, the rotation axis of the RP lever 130, and the rotation axis of the emergency lever 140. A first end of the cancellation lever 240 is in contact with the roller 233 of the CP lever 230. On the other hand, as illustrated in FIG. 9, a second end of the cancellation lever 240 is in contact with the second pressing portion 142b of the emergency lever 140.

As illustrated in FIG. 9, a first end of the cancellation lever spring 240S is engaged with the second base 210, and a second end of the cancellation lever spring 240S is engaged with the cancellation lever 240. Thus, the cancellation lever spring 240S biases the cancellation lever 240 in the first rotational direction R61. The cancellation lever 240 is positioned by coming into contact with the stopper 211 of the second base 210.

In the second remote control unit 102, the CP lever 230 is biased by the CP lever spring 230S. Consequently, torque to rotate the CP lever 230 in the first rotational direction R91 is applied to the CP lever 230 by the CP lever spring 230S. On the other hand, the restoring forces of the closing lever springs 54S of the upper locking device 50 and the lower locking device 60 act on the closing cables C3 and C4 connected to the CP lever 230. That is, the CP lever 230 is biased by the closing cables C3 and C4. Consequently, torque to rotate the CP lever 230 in a second rotational direction R92 is applied to the CP lever 230 by the closing cables C3 and C4.

In the present embodiment, the torque corresponding to the pulling force of the closing cables C3 and C4 is greater than the torque corresponding to the restoring force of the CP lever spring 230S. However, as illustrated in FIG. 9, the cancellation lever 240 holds down the roller 233 of the CP lever 230, and thus the CP lever 230 is restricted from rotating in the second rotational direction R92 relative to the CA lever 220. Therefore, as long as the cancellation lever 240 holds down the roller 233 of the CP lever 230, the CP lever 230 can rotate integrally with the CA lever 220. In the state illustrated in FIG. 9, the central axis of the roller 233 of the CP lever 230 substantially coincides with the rotation center of the CA lever 220.

As illustrated in FIGS. 5 and 6, the second door lock actuator 260 includes an electric motor 261, a pinion 262 that rotates based on power transmitted from the electric motor 261, and a case 263 housing components of the second door lock actuator 260. Although not illustrated, the case 263 houses a speed reducer that decelerates and transmits the rotation of an output shaft of the electric motor 261 to the pinion 262. The second door lock actuator 260 is fixed to the second base 210 with fastening members such as screws. At this time, as illustrated in FIG. 9, the pinion 262 meshes with the sector gear 222 of the CA lever 220. In this respect, the second door lock actuator 260 can drive the CA lever 220.

### <Door Actuator 90>

As illustrated in FIG. 1, the door actuator 90 is disposed near one of the front links 31F. Although not illustrated, the door actuator 90 preferably includes an electric motor and a transmission mechanism that transmits the power of the electric motor to the front door 40F. The door actuator 90 causes an operation to open the front door 40F in the opening direction and an operation to close the front door 40F in the closing direction.

### <Cables C1 to C7>

The plurality of cables C1 to C7 are, for example, Bowden cables. The plurality of cables C1 to C7 may be rods with high rigidity. The upper opening cable C1 corresponds to a “first opening cable”, and the lower opening cable C2 corresponds to a “second opening cable”. The upper closing cable C3 corresponds to a “first closing cable”, and the lower closing cable C4 corresponds to a “second closing cable”.

### <Door Control Device 300>

The door control device 300 is a processing circuit including a CPU and memory. The memory stores a program to be executed by the CPU. The door control device 300 controls the first door lock actuator 75, the second door lock actuator 260, and the door actuator 90, based on operation command signals input from opening and closing switches disposed near the driver's seat, near the front door 40F, on a portable device, etc.

When an opening operation command signal to cause the opening operation on the front door 40F is input, the door control device 300 causes the first door lock actuator 75 to perform a release operation to release the restraint of the front door 40F to the vehicle body 20. Subsequently, when the release operation is completed, the door control device 300 stops the first door lock actuator 75 and causes the door actuator 90 to perform an operation to open the front door 40F to the fully opened position. When the front door 40F reaches the fully opened position, the door control device 300 stops the door actuator 90.

When a closing operation command signal for the front door 40F is transmitted, the door control device 300 causes the door actuator 90 to perform an operation to close the front door 40F to the fully closed position. When the front door 40F reaches a position near the fully closed position, the door control device 300 stops the door actuator 90. Subsequently, the door control device 300 causes the first door lock actuator 75 and the second door lock actuator 260 to perform a closing operation to restrain the front door 40F to the vehicle body 20. When the closing operation is completed, the door control device 300 stops the first door lock actuator 75 and the second door lock actuator 260. Further, the door control device 300 returns the first door lock actuator 75 and the second door lock actuator 260 to their initial states before the start of the closing operation.

### <Functions of the Present Embodiment>

### <Closing Operation on Door Locking Devices>

The closing operation performed by the first door lock actuator 75 and the second door lock actuator 260 will be described together with the closing operation on the front door 40F performed by the door actuator 90.

As illustrated in FIG. 2, when the front door 40F is located in the opening direction from the fully closed position, the upper locking device 50, the lower locking device 60, and the front locking device 70 are in an unlatched state. Specifically, the latch 51 is located at an unlatched position where the latch 51 is rotated in the first rotational direction R11 the most in the rotation range of the latch 51 by the restoring force of the latch spring 51S. The pawl 52 is located at an engaging position where the pawl 52 is rotated in the second rotational direction R22 the most in the rotation range of the pawl 52 by the restoring force of the pawl spring 52S. The unlatched position is a position at which the latch 51 is unable to engage the striker 22. When the latch 51 is located at the unlatched position, the pawl 52 located at the engaging position is not engaged with the latch 51.

When the front door 40F is moved to the vicinity of the fully closed position by the door actuator 90, the states of the upper locking device 50, the lower locking device 60, and the front locking device 70 change. Specifically, as indicated by a two-dot chain line in FIG. 2, the striker 22 comes into contact with the latch 51 in the upper locking device 50, the lower locking device 60, and the front locking device 70. When the closing operation on the front door 40F is continued after the striker 22 comes into contact with the latch 51, the latch 51 is pressed by the striker 22 to rotate in a second rotational direction R12. At this time, the pawl 52 slides with the latch 51. Then, the pawl 52 rotates in a first rotational direction R21 from the engaging position.

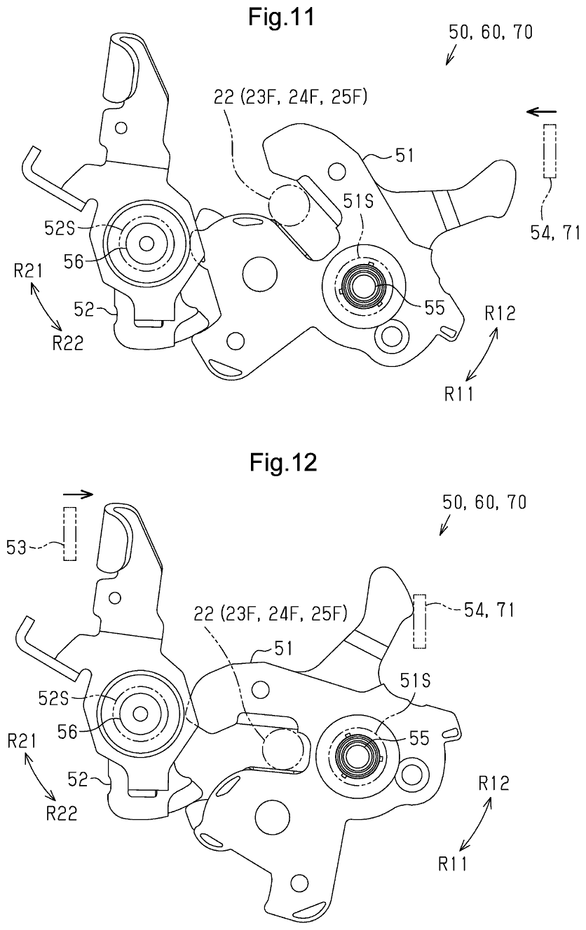

When the rotation of the latch 51 is continued with the closing operation on the front door 40F, the pawl 52 stops sliding with the latch 51. Then, the pawl 52 rotates in the second rotational direction R22 due to the restoring force of the pawl spring 52S. That is, as illustrated in FIG. 11, the pawl 52 returns to the engaging position to engage the latch 51. Consequently, as long as the pawl 52 remains at the engaging position, the latch 51 is prevented from rotating toward the unlatched position. Hereinafter, the position of the latch 51 illustrated in FIG. 11 is referred to as a half-latched position.

When the latch 51 rotates to the half-latched position, the drive of the door actuator 90 is stopped. Subsequently, the first door lock actuator 75 and the second door lock actuator 260 start the closing operation. The timing at which the first door lock actuator 75 and the second door lock actuator 260 start the closing operation may be before the timing at which the drive of the door actuator 90 is completed.

First, the closing operation of the first door lock actuator 75 will be described. As illustrated in FIG. 4, in the front locking device 70, the first door lock actuator 75 rotates the closing lever 71 in the first rotational direction R41. Then, as indicated by a solid arrow in FIG. 11, a distal end portion of the closing lever 71 moves toward the latch 51. That is, the latch 51 is pressed by the closing lever 71 to rotate in the second rotational direction R12. At this time, the pawl 52 slides with the latch 51. Then, the pawl 52 rotates in the first rotational direction R21 from the engaging position.

When the rotation of the latch 51 in the second rotational direction R12 is continued with the rotation of the closing lever 71, the pawl 52 stops sliding with the latch 51. Then, the pawl 52 rotates in the second rotational direction R22 due to the restoring force of the pawl spring 52S. That is, as illustrated in FIG. 12, the pawl 52 returns to the engaging position to engage the latch 51. Consequently, as long as the pawl 52 remains at the engaging position, the latch 51 is prevented from rotating toward the unlatched position. Hereinafter, the position of the latch 51 illustrated in FIG. 12 is referred to as a fully latched position, and the state of the front locking device 70 is referred to as a fully latched state. After the latch 51 has rotated to the fully latched position, the first door lock actuator 75 rotates the closing lever 71 in the second rotational direction R42. As a result, the closing lever 71 returns to its initial position before the start of the closing operation. In other words, the closing lever 71 separates from the latch 51.

Next, the closing operation of the second door lock actuator 260 will be described.

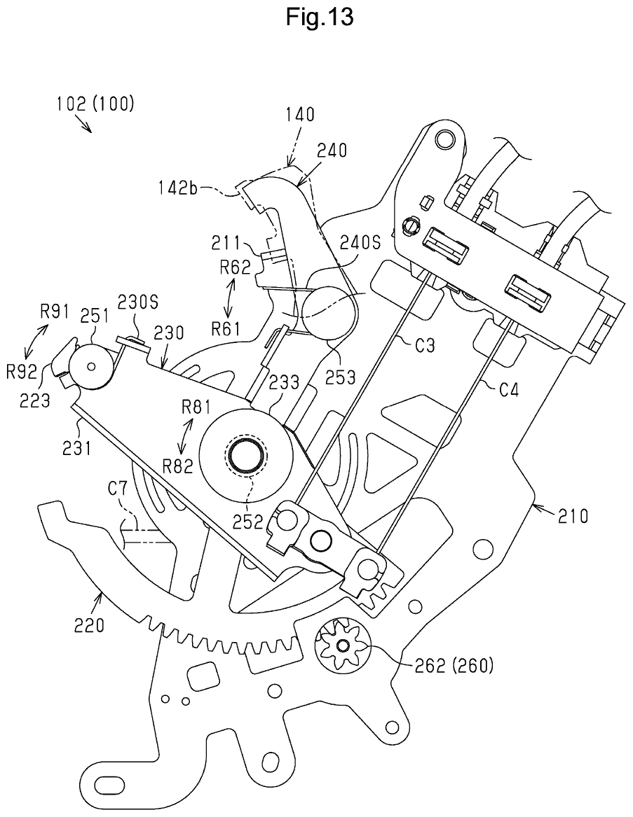

As illustrated in FIG. 9, in the remote control device 100, the second door lock actuator 260 rotates the CA lever 220 in a first rotational direction R81. In the state illustrated in FIG. 9, the CA lever 220 and the CP lever 230 rotate substantially integrally, and thus the CP lever 230 rotates in the first rotational direction R81 together with the CA lever 220. As a result, as illustrated in FIG. 13, the CP lever 230 pulls the closing cables C3 and C4 via the balancer 232. Then, as illustrated in FIG. 3, in the upper locking device 50 and the lower locking device 60, the closing lever 54 rotates in the first rotational direction R41. As a result, as in the front locking device 70, the latch 51 rotates to the fully latched position, and the pawl 52 is disposed at the engaging position. That is, the upper locking device 50 and the lower locking device 60 transition to the fully latched state. In this respect, the first rotational direction R81 corresponds to a “first forward rotational direction”, and a second rotational direction R82 corresponds to a “first reverse rotational direction”.

After the latch 51 has rotated to the fully latched position, in the remote control device 100, the second door lock actuator 260 rotates the CA lever 220 in the second rotational direction R82. In the state illustrated in FIG. 13, the CA lever 220 and the CP lever 230 rotate substantially integrally, and thus the CP lever 230 rotates in the second rotational direction R82 together with the CA lever 220. As a result, as illustrated in FIG. 9, the closing cables C3 and C4 are released from being pulled by the CP lever 230. That is, as illustrated in FIG. 3, in the upper locking device 50 and the lower locking device 60, the closing lever 54 rotates in the second rotational direction R42 according to the restoring force of the closing lever spring 54S. As a result, the closing lever 54 returns to its initial position before the start of the closing operation. In other words, the closing lever 54 separates from the latch 51.

Thus, the closing operation performed by the first door lock actuator 75 and the second door lock actuator 260 is completed. In the present embodiment, the front locking device 70 transitions to the fully latched state by the closing operation of the first door lock actuator 75. Likewise, the upper locking device 50 and the lower locking device 60 transition to the fully latched state by the closing operation of the second door lock actuator 260. As a result, the front edge portion, the upper rear edge portion, and the lower rear edge portion of the front door 40F are restrained to the vehicle body 20.

### <Closing Cancellation Operation on Door Locking Devices>

As illustrated in FIGS. 9 and 13, in the closing operation, the second door lock actuator 260 causes the remote control device 100 to pull the closing cables C3 and C4. Thus, the second door lock actuator 260 causes the upper locking device 50 and the lower locking device 60 to transition from the half-latched state to the fully latched state. Here, consider a case where the second door lock actuator 260 malfunctions in a state where the second door lock actuator 260 has pulled the closing cables C3 and C4. The malfunction of the second door lock actuator 260 is a case where the closing cables C3 and C4 cannot be released from being pulled, such as a case where the electric motor 261 of the second door lock actuator 260 fails or the CA lever 220 is fixed.

As illustrated in FIGS. 12 and 13, when the closing cables C3 and C4 are pulled, in the upper locking device 50 and the lower locking device 60, the closing lever 54 restricts the rotation of the latch 51 in the first rotational direction R11. Consequently, even when the first door lock actuator 75 performs the release operation, the latch 51 cannot rotate toward the unlatched position. That is, the first door lock actuator 75 is prevented from causing the upper locking device 50 and the lower locking device 60 to transition to the unlatched state. As a result, an operation to open the front door 40F from the fully closed position cannot be performed. Therefore, a closing cancellation operation is performed to allow the lower locking device 60 and the front locking device 70 to transition to the unlatched state even in cases as described above.

As illustrated in FIG. 13, under conditions where the closing cancellation operation is required, the CP lever 230 is pulling the closing cables C3 and C4. That is, the reaction force to the pulling force on the closing cables C3 and C4 acts on the CP lever 230. However, the cancellation lever 240 holds down the roller 233 of the CP lever 230. Thus, the CP lever 230 is restricted from rotating relative to the CA lever 220 in the second rotational direction R92, based on the reaction force.

The closing cancellation operation is started when the user pulls the emergency cable C7 via the operating part 80. In the remote control device 100, when the emergency cable C7 is pulled, the emergency lever 140 rotates in a second rotational direction R62. When the emergency lever 140 rotates in the second rotational direction R62, the second pressing portion 142b of the emergency lever 140 presses the cancellation lever 240. As a result, the cancellation lever 240 rotates in the second rotational direction R62. The second rotational direction R62 corresponds to a “third forward rotational direction” for the emergency lever 140.

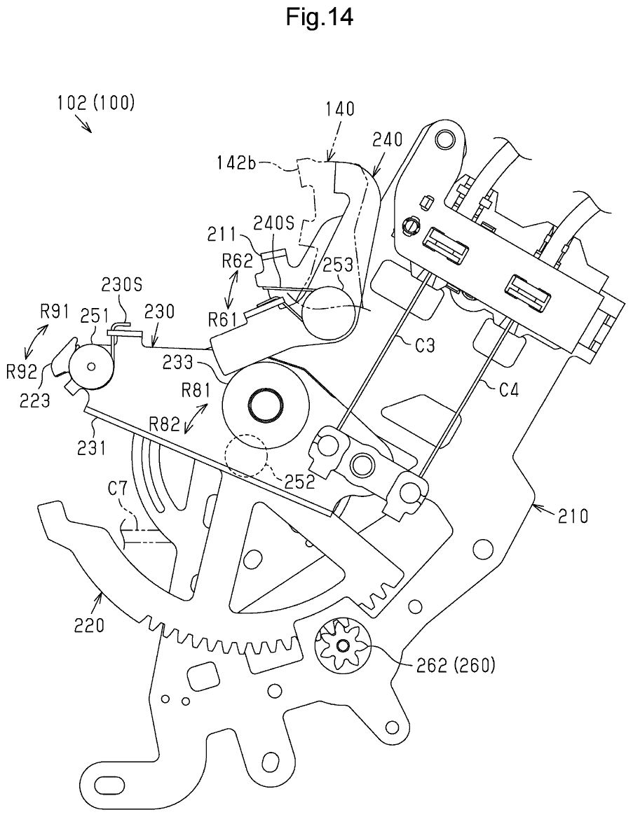

As illustrated in FIGS. 13 and 14, when the cancellation lever 240 rotates in the second rotational direction R62, the cancellation lever 240 is disengaged from the roller 233 of the CP lever 230. In other words, the cancellation lever 240 rotates from a restriction position at which the relative rotation between the CP lever 230 and the CA lever 220 is restricted to an allowance position at which the relative rotation between the CP lever 230 and the CA lever 220 is allowed. Consequently, the CP lever 230 rotates about the axis of the connecting shaft 251 due to the reaction force to the pulling force on the closing cables C3 and C4. Specifically, the CP lever 230 rotates, in the second rotational direction R92, relative to the CA lever 220 that cannot rotate. Thus, the remote control device 100 releases the closing cables C3 and C4 from being pulled by the CP lever 230.

As a result, as illustrated in FIG. 3, in the upper locking device 50 and the lower locking device 60, the closing lever 54 rotates in the second rotational direction R42. Consequently, the closing lever 54 is not present in the rotational direction of the latch 51 toward the unlatched position. That is, by performing the release operation, the upper locking device 50 and the lower locking device 60 are allowed to transition to the unlatched state.

Although the closing cancellation operation on the second door lock actuator 260 has been described above, the above-described problems may also occur when the first door lock actuator 75 performs the closing operation. Therefore, it is preferable that the closing cancellation operation be performed also on the first door lock actuator 75 by pulling the emergency cable C7. Such a closing cancellation operation is described, for example, in JP 2016-30982 A.

### <Release Operation on Door Locking Devices>

The release operation performed by the first door lock actuator 75 will be described.

As illustrated in FIG. 12, when the front door 40F is located at the fully closed position, the upper locking device 50, the lower locking device 60, and the front locking device 70 are in the fully latched state. Specifically, in the upper locking device 50, the lower locking device 60, and the front locking device 70, the latch 51 is located at the fully latched position, and the pawl 52 is located at the engaging position. Consequently, the latch 51 is prevented from rotating toward the unlatched position.

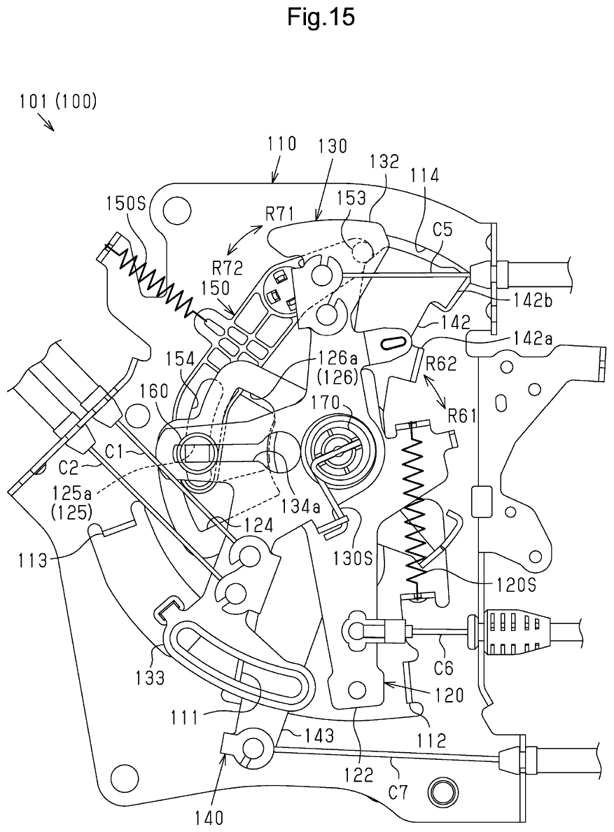

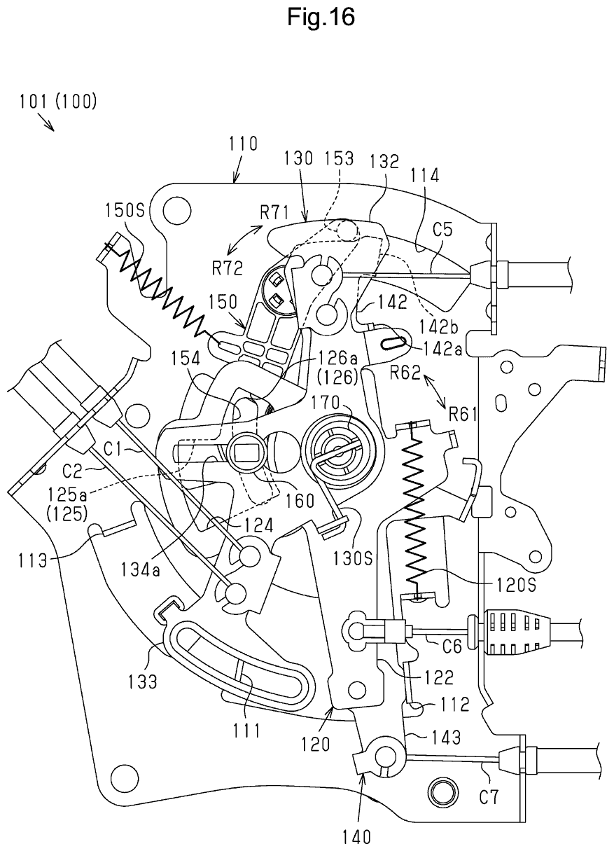

As illustrated in FIG. 4, in the release operation, the first door lock actuator 75 rotates the release lever 72 in the second rotational direction R52. Then, the release lever 72 pulls the release cable C6. As illustrated in FIG. 15, when the release cable C6 is pulled, the RA lever 120 rotates in the second rotational direction R62 in the remote control device 100. The RA lever 120 is connected to the RP lever 130 via the locking pin 160. Thus, when the RA lever 120 rotates in the second rotational direction R62, the RP lever 130 rotates in the second rotational direction R62 together with the RA lever 120. Specifically, the first side surface 125a of the RA lever 120 presses the locking pin 160 in the second rotational direction R62, and the locking pin 160 presses the RP lever 130 in the second rotational direction R62, whereby the RP lever 130 rotates. As a result, the RP lever 130 pulls the opening cables C1, C2, and C5.

Then, as illustrated in FIG. 3, in the upper locking device 50 and the lower locking device 60, the opening lever 53 rotates in a second rotational direction R32. As illustrated in FIG. 4, in the front locking device 70, the opening lever 53 rotates in the second rotational direction R32. Consequently, as indicated by a solid arrow in FIG. 12, the pawl 52 is pressed by the opening lever 53 to rotate in the first rotational direction R21. That is, the pawl 52 is disengaged from the latch 51. As a result, the latch 51 rotates in the first rotational direction R11 according to the restoring force of the latch spring 51S, to be disposed at the unlatched position illustrated in FIG. 2. In other words, the upper locking device 50, the lower locking device 60, and the front locking device 70 transition to the unlatched state. In this respect, the second rotational direction R62 corresponds to a “second forward rotational direction”, and the first rotational direction R61 corresponds to a “second reverse rotational direction”.

When the upper locking device 50, the lower locking device 60, and the front locking device 70 have entered the unlatched state, as illustrated in FIG. 4, the first door lock actuator 75 rotates the release lever 72 in the first rotational direction R51 to release the release cable C6 from being pulled. As illustrated in FIG. 7, when the release cable C6 is released from being pulled in the remote control device 100, the RA lever 120 rotates in the first rotational direction R61 due to the restoring force of the RA lever spring 120S. In addition, the RP lever 130 rotates in the first rotational direction R61 due to the restoring force of the RP lever spring 130S. Thus, the RA lever 120 and the RP lever 130 return to their initial positions before the release operation. As a result, the opening cables C1, C2, and C5 are released from being pulled. As illustrated in FIGS. 3 and 4, in the upper locking device 50, the lower locking device 60, and the front locking device 70, the opening lever 53 returns to its initial position before the release operation.

### <Release Cancellation Operation on Door Locking Devices>

As illustrated in FIGS. 4 and 15, in the release operation, the first door lock actuator 75 pulls the opening cables C1, C2, and C5 via the release cable C6 and the remote control device 100. Thus, the first door lock actuator 75 causes the upper locking device 50, the lower locking device 60, and the front locking device 70 to transition from the fully latched state to the unlatched state. Here, consider a case where the first door lock actuator 75 malfunctions in a state where the first door lock actuator 75 has pulled the opening cables C1, C2, and C5. The malfunction of the first door lock actuator 75 is a case where the opening cables C1, C2, and C5 cannot be released from being pulled, such as a case where the electric motor of the first door lock actuator 75 fails or the release lever 72 is fixed.

As illustrated in FIG. 15, in a state where the opening cables C1, C2, and C5 have been pulled, the pawl 52 cannot engage the latch 51 in the upper locking device 50, the lower locking device 60, and the front locking device 70. Consequently, even when the first door lock actuator 75 and the second door lock actuator 260 can rotate the latch 51 to the fully latched position by performing the closing operation, the latch 51 cannot be kept at the fully latched position. That is, the first door lock actuator 75 and the second door lock actuator 260 are prevented from causing the upper locking device 50, the lower locking device 60, and the front locking device 70 to transition to the fully latched state. Therefore, a release cancellation operation is performed to allow the upper locking device 50, the lower locking device 60, and the front locking device 70 to transition to the fully latched state even in cases as described above.

As illustrated in FIG. 15, under conditions where the release cancellation operation is required, the release cable C6 is in a pulled state. Consequently, the RA lever 120 cannot rotate in the first rotational direction R61. The RP lever 130 is connected to the RA lever 120 via the locking pin 160. Specifically, the locking pin 160 is in contact with the first side surface 125a demarcating the first portion 125 of the RA lever 120. Consequently, the locking pin 160 is prevented from moving in the first rotational direction R61. Since the locking pin 160 cannot move in the first rotational direction R61, the RP lever 130 is also prevented from rotating in the first rotational direction R61.

The release cancellation operation is started when the user pulls the emergency cable C7 via the operating part 80. As illustrated in FIGS. 15 and 16, in the remote control device 100, when the emergency cable C7 is pulled, the emergency lever 140 rotates in the second rotational direction R62 until it comes into contact with the stopper 112. Here, when the emergency lever 140 contacts the stopper 112, the user can no longer pull the emergency cable C7 via the operating part 80. Thus, the user can recognize that the operating part 80 has been operated by a required amount when the emergency lever 140 contacts the stopper 112.

As illustrated in FIGS. 15 and 16, the emergency lever 140 presses the engaging shaft 153 of the locking lever 150 when rotating in the second rotational direction R62. Consequently, the locking lever 150 rotates in a second rotational direction R72. The locking lever 150 presses the locking pin 160 toward the axis of the lever support shaft 170 when rotating in the second rotational direction R72. Then, the locking pin 160 moves along the sliding groove 154 in the locking lever 150 and moves along the guide groove 134a in the RP lever 130. Further, the locking pin 160 moves inside the guide hole 124 in the RA lever 120. Specifically, the locking pin 160 moves from the first portion 125 to the second portion 126 of the guide hole 124.

As illustrated in FIG. 16, when the locking lever 150 rotates the most in the second rotational direction R72, the locking pin 160 is no longer in contact with the first side surface 125a that demarcates the first portion 125 of the guide hole 124. That is, the locking pin 160 is displaced from the connection position at which the RA lever 120 and the RP lever 130 are connected relatively non-rotatably to a connection release position at which the RA lever 120 and the RP lever 130 are allowed to rotate relatively. As a result, the RP lever 130 and the locking pin 160 become rotatable relative to the RA lever 120 in the first rotational direction R61.

However, when the emergency lever 140 rotates until it comes into contact with the stopper 112, the first pressing portion 142a of the emergency lever 140 comes into contact with the second arm 132 of the RP lever 130. Consequently, the RP lever 130 is restricted from rotating in the first rotational direction R61 by the emergency lever 140.

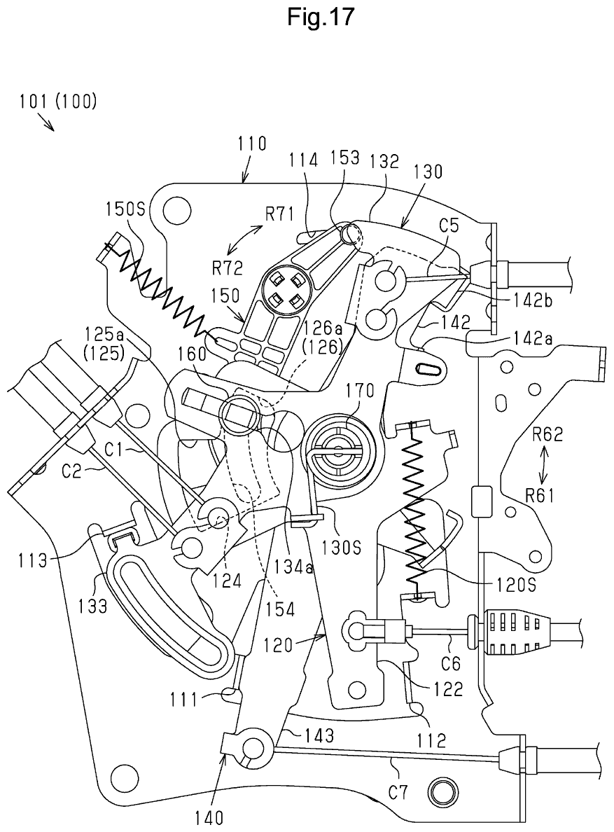

Subsequently, when the user terminates the operation on the operating part 80, the emergency cable C7 is released from being pulled. As illustrated in FIG. 17, when the emergency cable C7 is released from being pulled, the emergency lever 140 becomes rotatable in the first rotational direction R61, and thus the RP lever 130 also becomes rotatable in the first rotational direction R61. Consequently, the RP lever 130 and the emergency lever 140 rotate in the first rotational direction R61 due to the restoring force of the RP lever spring 130S.

The emergency lever 140 comes into contact with the stopper 111 to return to its initial position before the release cancellation operation. The RP lever 130 comes into contact with the stopper 113 to return to its initial position before the release operation. At the point where the RP lever 130 returns to its initial position, the opening cables C1, C2, and C5 are released from being pulled. As a result, as illustrated in FIGS. 3 and 4, in the upper locking device 50, the lower locking device 60, and the front locking device 70, the opening lever 53 returns to its initial position before the release operation. Thus, the upper locking device 50, the lower locking device 60, and the front locking device 70 are allowed to transition to the fully latched state by the closing operation.

When the emergency lever 140 rotates in the first rotational direction R61, the emergency lever 140 separates from the locking lever 150. However, as illustrated in FIGS. 7 and 17, since the position of the locking pin 160 is different after the release cancellation operation is performed, the locking lever 150 is disposed at a position different from its initial position.

### <Effects of the Present Embodiment>

(1) In the case where the first door lock actuator 75 malfunctions while performing the release operation, the release cancellation operation is performed. This brings the upper locking device 50, the lower locking device 60, and the front locking device 70 into a state of being able to transition to the fully latched state. On the other hand, in the case where the first door lock actuator 75 and the second door lock actuator 260 malfunction while performing the closing operation, the closing cancellation operation is performed. This brings the upper locking device 50, the lower locking device 60, and the front locking device 70 into a state of being able to transition to the unlatched state.

Here, the release cancellation operation and the closing cancellation operation are performed by the user pulling the emergency cable C7 via the operating part 80. In other words, the user does not need to perform different operations on the operating part 80 when performing the release cancellation operation and the closing cancellation operation. Thus, the remote control device 100 can enhance the convenience of the user when the release cancellation operation and the closing cancellation operation are performed. In other words, the remote control device 100 can make the operation to release the closing cables C3 and C4 from being pulled and the operation to release the opening cables C1 and C2 from being pulled simple for the user.
(2) In the release cancellation operation, the remote control device 100 moves the locking pin 160 from the connection position to the connection release position according to the rotation of the emergency lever 140. Thus, the remote control device 100 allows the rotation of the RP lever 130 relative to the RA lever 120. Consequently, the remote control device 100 enables the release cancellation operation with the relatively simple configuration.
(3) In the closing cancellation operation, the remote control device 100 rotates the cancellation lever 240 from the restriction position to the allowance position, according to the rotation of the emergency lever 140. Thus, the remote control device 100 allows the CP lever 230 to rotate relative to the CA lever 220. Consequently, the remote control device 100 enables the closing cancellation operation with the relatively simple configuration.
(4) In the remote control device 100, the rotation axes of the RA lever 120, the RP lever 130, the cancellation lever 240, and the emergency lever 140 coincide. This reduces transmission loss during power transmission between the RA lever 120, the RP lever 130, and the emergency lever 140. This also reduces transmission loss during power transmission between the emergency lever 140 and the cancellation lever 240.
(5) The vehicle 10 includes the first door lock actuator 75 to perform the closing operation on the front locking device 70, and the second door lock actuator 260 to perform the closing operation on the upper locking device 50 and the lower locking device 60. This eliminates the need for a large door lock actuator as compared with a case where a single door lock actuator performs the closing operation on the upper locking device 50, the lower locking device 60, and the front locking device 70.

The torque required to perform a release operation on a door locking device is smaller than the torque required to perform a closing operation on the door locking device. Therefore, the release operation on the upper locking device 50, the lower locking device 60, and the front locking device 70 can be performed by the single and small first door lock actuator 75.
(6) In the case where the first door lock actuator 75 of the front locking device 70 malfunctions when the front door 40F is disposed at the fully closed position, the opening operation on the front door 40F cannot be performed. In this regard, the remote control device 100 rotates the emergency lever 140 in the second rotational direction R62 by the pulling of the emergency cable C7 by the operation of the operating part 80. In this case, the RP lever 130 is pressed by the first pressing portion 142a of the emergency lever 140, thereby rotating in the second rotational direction R62. That is, the RP lever 130 pulls the opening cables C1, C2, and C5. Thus, the remote control device 100 can release the restraint of the front door 40F at the fully closed position to the vehicle body 20.

### <Modifications>

The present embodiment can be modified as follows to be implemented. The present embodiment and the following modifications can be implemented in combination with each other to the extent that no technical contradictions occur.
In the closing cancellation operation, the CP lever 230 may be linearly displaced relative to the CA lever 220 to release the closing cables C3 and C4 from being pulled by the CP lever 230. Likewise, in the release cancellation operation, the RP lever 130 may be linearly displaced relative to the RA lever 120 to release the opening cables C1, C2, and C5 from being pulled by the RP lever 130.
In the remote control device 100, the rotation axes of the RA lever 120, the RP lever 130, the emergency lever 140, and the cancellation lever 240 may not coincide. This eliminates the need to consider the overlapping of a plurality of levers at the time of designing and at the time of assembling the remote control device 100.
The configuration of the rear door 40R may be different from the configuration of the front door 40F. For example, one of the front door 40F and the rear door 40R may include a center striker, and the other of the front door 40F and the rear door 40R may include a center locking device that is able to engage the center striker.
Of the first door lock actuator 75 and the second door lock actuator 260, the front door 40F may include only the first door lock actuator 75. In this case, the first door lock actuator 75 and the remote control device 100 are preferably configured to be able to pull the closing cables C3 and C4 in the closing operation.
In the front door 40F, the arrangement of two door locking devices, the upper locking device 50 and the lower locking device 60, can be appropriately changed. For example, the two door locking devices may be arranged side by side in the front-rear direction along the lower edge of the front door 40F.
In the front door 40F, the first door lock actuator 75 may not be integrally formed with the front locking device 70. Likewise, in the front door 40F, the second door lock actuator 260 may not be integrally formed with the remote control device 100.
The front door 40F may be a sliding door that opens and closes the front opening 21F by moving in the front-rear direction.
The vehicle 10 only needs to include one of the front door 40F and the rear door 40R.
The remote control device 100 can also be applied to a back door that opens and closes an opening open at the back of the vehicle body 20.

### <Summary of the Present Embodiment>

The present embodiment has at least the following configuration.

A remote control device (100) is applied to a door (40F) that opens and closes a door opening (21) of a vehicle body (20) including a first striker (24F) and a second striker (25F). The door (40F) includes a first door locking device (50) that is able to transition to a fully latched state in which the first door locking device (50) is able to engage the first striker (24F), and to an unlatched state in which the first door locking device (50) is unable to engage the first striker (24F), and a second door locking device (60) that is able to transition to a fully latched state in which the second door locking device (60) is able to engage the second striker (25F), and to an unlatched state in which the second door locking device (60) is unable to engage the second striker (25F). The remote control device (100) includes a closing passive lever (230) connected to the first door locking device (50) via a first closing cable (C3) and connected to the second door locking device (60) via a second closing cable (C4), a closing active lever (220) configured to drive the closing passive lever (230), a release passive lever (130) connected to the first door locking device (50) via a first opening cable (C1) and connected to the second door locking device (60) via a second opening cable (C2), a release active lever (120) configured to drive the release passive lever (130), and an emergency lever (140) configured to drive the closing passive lever (230) and the release passive lever (130). The first door locking device (50) is caused to transition to the unlatched state by the first opening cable (C1) being pulled, and is caused to transition to the fully latched state by the first closing cable (C3) being pulled. The second door locking device (60) is caused to transition to the unlatched state by the second opening cable (C2) being pulled, and is caused to transition to the fully latched state by the second closing cable (C4) being pulled. The closing active lever (220) causes the closing passive lever (230) to pull the first closing cable (C3) and the second closing cable (C4) when rotating in a first forward rotational direction (R81), and releases the first closing cable (C3) and the second closing cable (C4) from being pulled by the closing passive lever (230) when rotating in a first reverse rotational direction (R82) that is a direction opposite to the first forward rotational direction (R81). The release active lever (120) causes the release passive lever (130) to pull the first opening cable (C1) and the second opening cable (C2) when rotating in a second forward rotational direction (R62), and releases the first opening cable (C1) and the second opening cable (C2) from being pulled by the release passive lever (130) when rotating in a second reverse rotational direction (R61) that is a direction opposite to the second forward rotational direction (R62). The emergency lever (140), when rotating in a third forward rotational direction (R62), releases the first closing cable (C3) and the second closing cable (C4) from being pulled by the closing passive lever (230) by displacing the closing passive lever (230) relative to the closing active lever (220), and releases the first opening cable (C1) and the second opening cable (C2) from being pulled by the release passive lever (130) by displacing the release passive lever (130) relative to the release active lever (120).

In the remote control device, when the closing active lever drives the closing passive lever, the first closing cable and the second closing cable are pulled. As a result, the first door locking device and the second door locking device transition to the fully latched state. Here, in a case where a problem occurs in an actuator that drives the closing passive lever, for example, the first closing cable and the second closing cable may remain pulled. That is, the first door locking device and the second door locking device may be put in a state of not being able to transition to the unlatched state. Under such conditions, the emergency lever is rotated in the third forward rotational direction. As a result, the remote control device displaces the closing passive lever relative to the closing active lever, thereby releasing the first closing cable and the second closing cable from being pulled by the closing passive lever. Thus, the first door locking device and the second door locking device are brought into a state of being able to transition to the unlatched state.

In the remote control device, the release active lever drives the release passive lever, thereby pulling the first opening cable and the second opening cable. As a result, the first door locking device and the second door locking device transition to the unlatched state. Here, in a case where a problem occurs in an actuator that drives the release passive lever, for example, the first opening cable and the second opening cable may remain pulled. That is, the first door locking device and the second door locking device may be put in a state of not being able to transition to the fully latched state. Under such conditions, the emergency lever is rotated in the third forward rotational direction. As a result, the remote control device displaces the release passive lever relative to the release active lever, thereby releasing the first opening cable and the second opening cable from being pulled by the release passive lever. Thus, the first door locking device and the second door locking device are brought into a state of being able to transition to the fully latched state.

As described above, in the case where the first door locking device and the second door locking device are put in a state of not being able to transition to the fully latched state, and the case where the first door locking device and the second door locking device are put in a state of not being able to transition to the unlatched state, the emergency lever is rotated in the third forward rotational direction. Thus, the user of the remote control device can perform the same operation in either case. Therefore, the remote control device can enhance the convenience of the user. In other words, the remote control device can make the operation to release the opening cables from being pulled and the operation to release the closing cables from being pulled simple for the user.

The remote control device (100) preferably includes a locking pin (160) that is displaced between a connection position at which the release active lever (120) and the release passive lever (130) are connected relatively non-rotatably and a connection release position at which the release active lever (120) and the release passive lever (130) are allowed to rotate relatively, and a locking lever (150) configured to be driven by the emergency lever (140). The locking lever (150) preferably displaces the locking pin (160) from the connection position to the connection release position when the emergency lever (140) rotates in the third forward rotational direction (R62).

The remote control device moves the locking pin from the connection position to the connection release position when rotating the emergency lever in the third forward rotational direction. Thus, the remote control device allows the release passive lever to rotate relative to the release active lever. Consequently, the remote control device enables the rotation of the release passive lever relative to the release active lever with the relatively simple configuration.

The remote control device (100) preferably includes a cancellation lever (240) configured to be displaced between a restriction position at which the relative rotation of the closing passive lever (230) and the closing active lever (220) is restricted and an allowance position at which the relative rotation of the closing passive lever (230) and the closing active lever (220) is allowed, and configured to be driven by the emergency lever (140). The cancellation lever (240) is preferably configured to be displaced from the restriction position to the allowance position when the emergency lever (140) rotates in the third forward rotational direction (R62).

When rotating the emergency lever in the third forward rotational direction, the remote control device rotates the cancellation lever from the restriction position to the allowance position. Thus, the remote control device allows the rotation of the closing passive lever relative to the closing active lever. Consequently, the remote control device enables the rotation of the closing passive lever relative to the closing active lever with the relatively simple configuration.

In the remote control device (100), it is preferable that the rotation axis of the release active lever (120), the rotation axis of the release passive lever (130), the rotation axis of the emergency lever (140), and the rotation axis of the cancellation lever (240) coincide.

In the remote control device, the rotation axes of the release active lever, the release passive lever, the emergency lever, and the cancellation lever coincide. This reduces loss associated with power transmission between these levers.

REFERENCE SIGNS LIST

10: Vehicle, 20: Vehicle body, 21: Door opening, 22: Striker, 24F: Upper striker
(first striker), 25F: Lower striker (second striker), 40F: Front door (door), 50: Upper
locking device (first door locking device), 60: Lower locking device (second door
locking device), 100: Remote control device, 120: Release active lever, 130: Release
passive lever, 140: Emergency lever, 150: Locking lever, 160: Locking pin, 220:
Closing active lever, 230: Closing passive lever, 240: Cancellation lever, C1: Upper
opening cable (first opening cable), C2: Lower opening cable (second opening cable),
C3: Upper closing cable (first closing cable), C4: Lower closing cable (second closing
cable), R61: First rotational direction (second reverse rotational direction), R62: Second
rotational direction (second forward rotational direction, third forward rotational
direction), R81: First rotational direction (first forward rotational direction), and R82:
Second rotational direction (first reverse rotational direction)

1. A remote control device applied to a door that opens and closes a door opening of a vehicle body including a first striker and a second striker, the door including a first door locking device that is able to transition to a fully latched state in which the first door locking device is able to engage the first striker, and to an unlatched state in which the first door locking device is unable to engage the first striker, and a second door locking device that is able to transition to a fully latched state in which the second door locking device is able to engage the second striker, and to an unlatched state in which the second door locking device is unable to engage the second striker, the remote control device comprising:
a closing passive lever connected to the first door locking device via a first closing cable and connected to the second door locking device via a second closing cable;
a closing active lever configured to drive the closing passive lever;
a release passive lever connected to the first door locking device via a first opening cable and connected to the second door locking device via a second opening cable;
a release active lever configured to drive the release passive lever; and
an emergency lever configured to drive the closing passive lever and the release passive lever, wherein
the first door locking device is caused to transition to the unlatched state by the first opening cable being pulled, and is caused to transition to the fully latched state by the first closing cable being pulled,
the second door locking device is caused to transition to the unlatched state by the second opening cable being pulled, and is caused to transition to the fully latched state by the second closing cable being pulled,
the closing active lever causes the closing passive lever to pull the first closing cable and the second closing cable when rotating in a first forward rotational direction, and releases the first closing cable and the second closing cable from being pulled by the closing passive lever when rotating in a first reverse rotational direction that is a direction opposite to the first forward rotational direction,
the release active lever causes the release passive lever to pull the first opening cable and the second opening cable when rotating in a second forward rotational direction, and releases the first opening cable and the second opening cable from being pulled by the release passive lever when rotating in a second reverse rotational direction that is a direction opposite to the second forward rotational direction, and
when rotating in a third forward rotational direction,
the emergency lever releases the first closing cable and the second closing cable from being pulled by the closing passive lever by displacing the closing passive lever relative to the closing active lever, and
the emergency lever releases the first opening cable and the second opening cable from being pulled by the release passive lever by displacing the release passive lever relative to the release active lever.

2. The remote control device according to claim 1, comprising:
a locking pin that is displaced between a connection position at which the release active lever and the release passive lever are connected relatively non-rotatably and a connection release position at which the release active lever and the release passive lever are allowed to rotate relatively; and
a locking lever configured to be driven by the emergency lever, wherein
the locking lever displaces the locking pin from the connection position to the connection release position when the emergency lever rotates in the third forward rotational direction.

3. The remote control device according to claim 2, comprising
a cancellation lever configured to be displaced between a restriction position at which relative rotation of the closing passive lever and the closing active lever is restricted and an allowance position at which relative rotation of the closing passive lever and the closing active lever is allowed, the cancellation lever being configured to be driven by the emergency lever, wherein
the cancellation lever is configured to be displaced from the restriction position to the allowance position when the emergency lever rotates in the third forward rotational direction.

4. The remote control device according to claim 3, wherein
a rotation axis of the release active lever, a rotation axis of the release passive lever, a rotation axis of the emergency lever, and a rotation axis of the cancellation lever coincide.
